(19) United States
(12) Patent Application Publication
(10) Pub. No.: US 2026/0079838 A1
(43) Pub. Date: Mar. 19, 2026

(54) GARBAGE COLLECTION BASED ON VTC VELOCITY

(71) Applicant: Micron Technology, Inc., Boise, ID (US)

(72) Inventor: Meng Wei, Shanghai (CN)

(21) Appl. No.: 18/888,894

(22) Filed: Sep. 18, 2024

(51) Int. Cl. G06F 12/02

(52) U.S. Cl. CPC G06F 12/0253; G06F 2212/7205

(57) ABSTRACT

This disclosure is directed to a memory device that performs garbage collection (GC) operations intelligently. The memory device generates a request to perform a GC operation on data stored on the memory device and, in response, accesses a valid translation unit count (VTC) velocity of each portion of a plurality of portions of the data stored on the memory device. The memory device selects an individual portion of the plurality of portions based on the VTC velocity of the individual portion and performs the GC operation on the selected individual portion.

### TECHNICAL FIELD

Examples of the disclosure relate generally to memory sub-systems and, more specifically, to performing garbage collection (GC) operations in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 is a block diagram illustrating an example computing system that includes a memory sub-system, in accordance with some examples.

FIG. 2 is a block diagram of a valid translation unit count (VTC) velocity component, in accordance with some examples.

FIG. 3 illustrates a diagram of different velocity areas generated by the VTC velocity component, in accordance with some examples.

FIG. 4 is a flow diagram of an example method to GC operations, in accordance with some examples.

FIG. 5 is a flow diagram of an example method to GC operations, in accordance with some examples.

FIG. 6 is a block diagram of an example computer system in which examples of the present disclosure may operate.

### DETAILED DESCRIPTION

The present disclosure is directed to a memory sub-system that intelligently performs GC operations. Specifically, the memory sub-system includes a memory controller that can keep track of the VTC velocity of different portions (e.g., block stripes (BSs)) stored on the memory device. The memory controller can then select target/candidate portions to perform GC operations based on the VTC velocities. For example, the memory controller can perform a GC operation on a candidate portion that has a lowest VTC velocity. This selection can continue for a certain number of iterations and/or until some condition or criterion is met. At that point, the memory controller can transition to performing the GC operations using a different scheme, such as based on the VTC (e.g., VTC value) of each portion. In some cases, the different scheme involves selecting a candidate portion on which to perform GC operations which has the lowest VTC relative to other portions. In this way, rather than always relying only on the VTC to perform GC operations, a dynamic approach is utilized which can improve or reduce the write amplification of the memory sub-system which improves the overall operations of the memory sub-system.

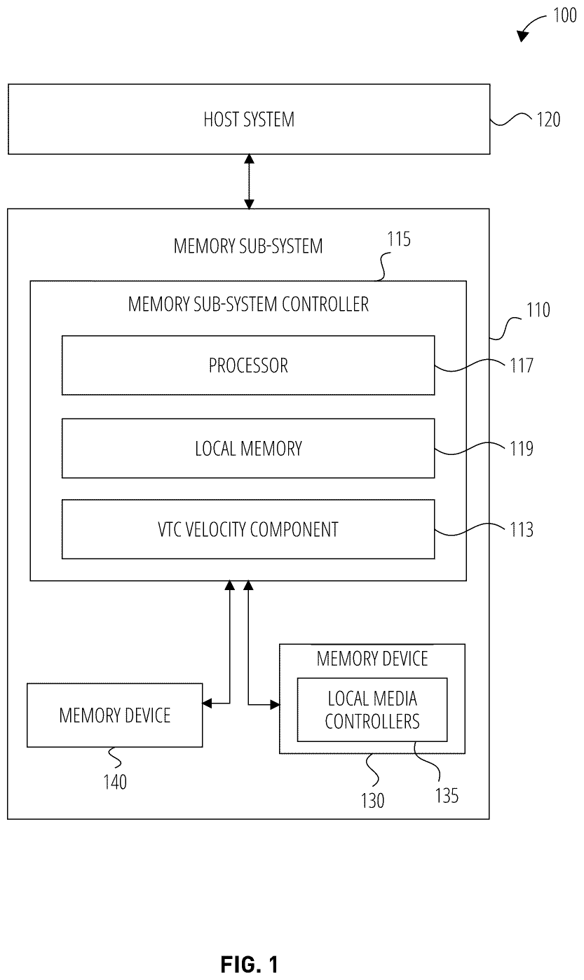

A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command, erase command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system may re-write previously written host data from a location of a memory device to a new location as part of garbage collection (GC) management operations. The data that is re-written, for example as initiated by the firmware, is hereinafter referred to as “GC data.”

“User data” hereinafter generally refers to host data and GC data. “System data” hereinafter refers to data that is created and/or maintained by the memory sub-system for performing operations in response to host requests and for media management. Examples of system data include, and are not limited to, system tables (e.g., logical-to-physical memory address mapping table, also referred to herein as a L2P table, data from logging, scratch pad data, and so forth).

A memory device can be a non-volatile memory device. A non-volatile memory device is a package of one or more die. Each die can be comprised of one or more planes. For some types of non-volatile memory devices (e.g., AND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are a raw memory device combined with a local embedded controller for memory management within the same memory device package. The memory device can be divided into one or more zones where each zone is associated with a different set of host data or user data or application.

Certain memory devices, such as NAND-type memory devices, comprise one or more blocks, (e.g., multiple blocks), with each of those blocks comprising multiple memory cells. For instance, a memory device can comprise multiple pages (also referred to as word lines (WLs)), with each page comprising a subset of memory cells of the memory device. A threshold voltage (VT) of a memory cell (of a block) can be the voltage at which the floating gate (e.g., NAND transistor), implementing the memory cell, turns on and conducts (e.g., to a bit line coupled to the memory cell). Generally, writing data to such memory devices involves programming (by way of a program operation) the memory devices at the page level of a block, and erasing data from such memory devices involves erasing the memory devices at the block level (e.g., page level erasure of data is not possible).

A memory device can comprise one or more cache blocks and one or more non-cache blocks, where data written to the memory device is first written to one or more cache blocks, which can facilitate faster write performance; and data stored on the cache blocks can eventually be moved (e.g., copied) to one or more non-cache blocks at another time (e.g., a time when the memory device is idle), which can facilitate higher storage capacity on the memory device. A cache block can comprise a single-level cell (SLC) block that comprises multiple SLCs, and a non-cache block can comprise a multiple-level cell (MLC) block that comprises multiple MLCs, a TLC block that comprises multiple tri-level cells (TLCs), or a quad-level cell (QLC) block that comprises QLCs. Writing first to one or more SLCs blocks can be referred to as SLC write caching or SLC caching (also referred to as buffering in SLC mode). Generally, when using traditional full SLC caching, an SLC block is released of data after data is moved from the SLC block to a non-cache block (e.g., QLC block) and the non-cache block is verified to be free of errors. Certain memory devices can collect multiple memory blocks into a single block, known as a block stripe which can span multiple memory planes across multiple memory dies.

Solid state drives (SSDs) face unique challenges in managing data due to the inherent characteristics of NAND flash memory. Unlike hard disk drives, NAND flash requires erasing entire blocks (e.g., BSs) before writing new data, necessitating a process called GC to free up space. Traditional garbage collection approaches, such as the greedy strategy, select victim (candidate) blocks based solely on the number of valid translation units (VTs) they contain, which is also referred to or represented by the VT count (VTC) or VTC value of each block. While simple to implement, this method is inefficient for certain workload patterns, particularly those with limited logical block address (LBA) ranges. The greedy approach fails to effectively distinguish between “hot” frequently updated data and “cold” rarely accessed data. This results in unnecessary movement of cold data during GC, wasting system resources and increasing write amplification (WA).

WA refers to the excess data written to NAND flash beyond what is requested by the host. Higher WA leads to decreased SSD performance and endurance. For workloads that repeatedly write to a limited LBA range, such as a 20% random write pattern, the greedy GC strategy can cause write amplification to increase by 8.5% or more compared to a full LBA range workload. Conventional approaches attempt to address this issue using complex versioning schemes for blocks, pages, or translation units/VTs. While these can help separate hot and cold data, they add overhead and complexity to the flash translation layer.

The disclosed techniques address these challenges by providing a memory controller that intelligently performs GC operations. Specifically, the disclosed memory controller can compute and keep track of the VTC velocity of different portions (e.g., block stripes (BSs)) stored on the memory device. The memory controller can then select target/candidate portions to perform GC operations based on the VTC velocities. For example, the memory controller can perform a GC operation on a candidate portion that has a lowest VTC velocity. This selection can continue for a certain number of iterations and/or until some condition or criterion is met. At that point, the memory controller can transition to performing the GC operations using a different scheme, such as the greedy approach that is based on the VTC (e.g., VTC value) of each portion. In this way, rather than always relying only on the VTC to perform GC operations, a dynamic approach is utilized which can improve or reduce the WA of the memory sub-system which improves the overall operations of the memory sub-system. This enables the memory sub-system to efficiently handle workloads with limited LBA ranges, reduce unnecessary data movement, and minimize WA without introducing excessive complexity. The disclosed memory controller can effectively separate hot and cold data, allowing the system to focus GC efforts on rarely updated areas while leaving frequently accessed data undisturbed or vice versa.

In some examples, the techniques described herein relate to a system including a memory device and a processing device, operatively coupled to the memory device. The processing device can generate a request to perform a GC operation (e.g., periodically) on data stored on the memory device. The processing device in response to generating the request, accesses a valid translation unit count (VTC) velocity of each portion of a plurality of portions of the data stored on the memory device; selects an individual portion of the plurality of portions based on the VTC velocity of the individual portion; and performs the GC operation on the selected individual portion. The plurality of portions can include a plurality of BSs.

The processing device can store, for each portion of the plurality of portions, a VTC when the respective portion was closed and can compute the VTC velocity of each portion as a function of the stored VTC when the respective portion was closed and a duration of time that has elapsed since the respective portion was closed. The processing device can obtain a first VTC value corresponding to the VTC value associated with the individual portion when the individual portion was closed and can obtain a second VTC value corresponding to a current VTC associated with the individual portion. The processing device can compute a difference between the first and second VTC values and can compute an individual duration of time that has elapsed since the individual portion was closed. In some cases, the processing device can compute the VTC velocity for the individual portion based on a division of the computed difference and the individual duration of time and can apply an amplification value to the computed VTC velocity for the individual portion.

In some examples, the VTC velocity of the individual portion includes a first VTC velocity and the processing device can compute a second VTC velocity for an additional portion of the plurality of portions. The processing device can determine that the first VTC velocity is lower than the second VTC velocity. The individual portion can be selected instead of the additional portion for performing the GC operation in response to determining that the first VTC velocity is lower than the second VTC velocity. The processing device can detect a condition for transitioning from selecting a target portion for performing the GC operation based on a VTC velocity of the target portion to selecting the target portion based on a corresponding VTC of the target portion. The processing device can, in response to determining that the condition is satisfied, select the target portion based on the corresponding VTC of the target portion relative to VTCs of remaining portions in the plurality of portions. The target portion selected based on the corresponding VTC can be selected in response to determining that the target portion is associated with a lowest VTC among VTCs of each of the plurality of portions.

In some cases, the processing device determines that selection of the target portion based on the VTC velocity has been performed for a threshold number of iterations. The processing device can determine that the condition is satisfied in response to determining that the selection of the target portion based on the VTC velocity has been performed for the threshold number of iterations. The processing device can obtain VTCs of each portion of the plurality of portions and identify a lowest VTC of the obtained VTCs. The processing device can select the target portion in response to determining that the target portion is associated with the lowest VTC.

The processing device can determine that the target portion selected based on identifying the lowest VTC is the same as the individual portion selected based on the VTC velocity of the individual portion. The processing device can determine that the condition is satisfied in response to determining that the target portion selected based on identifying the lowest VTC is the same as the individual portion selected based on the VTC velocity of the individual portion. The processing device can generate a cold velocity area including a first subset of the plurality of portions having corresponding VTC velocities that are below a VTC velocity threshold and can generate a hot velocity area including a second subset of the plurality of portions having the corresponding VTC velocities that are above the VTC velocity threshold. The VTC velocity threshold can be configurable by a host or user.

In some examples, the processing device can select the individual portion from the cold velocity area. The processing device can randomly select a first portion from the hot velocity area or cold velocity area and identify a lowest VTC candidate portion in the hot velocity area having a corresponding VTC that is lower than VTCs of other portions in the hot velocity area. The processing device can determine that the first portion that was randomly selected matches the lowest VTC candidate portion and can perform subsequent GC operations on the plurality of portions based on lowest VTCs of the plurality of portions in response to determining that the first portion that was randomly selected matches the lowest VTC candidate portion. The processing device can compute a BS score for each portion of the plurality of portions as a function of the VTC of each portion and the VTC velocity of each portion. The individual portion can be selected based on the BS score. The BS score for the individual portion can be computed by summing the VTC of the individual portion with the VTC velocity of the individual portion multiplied by a VTC velocity coefficient.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing system 100 that includes a memory sub-system 110, in accordance with some examples. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some examples, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, SLCs, can store one bit per cell. Other types of memory cells, such as MLCs, TLCs, QLCs, and penta-level cells (PLCs), can store multiple bits per cell. In some examples, each of the memory devices 130, 140 can include one or more arrays of memory cells such as SLCs, MLCs, TLCs, QLCs, or any combination of such. In some examples, a particular memory device can include an SLC portion, an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks or BSs. As used herein, a block comprising SLCs can be referred to as a SLC block, a block comprising MLCs can be referred to as a MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data at the memory devices 130, 140 and other such operations. The memory sub-system controller 115 can include hardware such as one or more integrated circuits and/or discrete components, a buffer memory, or a combination thereof. The hardware can include digital circuitry with dedicated (e.g., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some examples, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another example, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, GC operations, error detection and ECC operations, encryption operations, caching operations, and address translations between a logical address (e.g., LBA, namespace) and a physical memory address (e.g., physical block address) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some examples, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some examples, a memory device 130 is a managed memory device, which is a raw memory device combined with a local controller (e.g., local media controller 135) for media management within the same memory device package. An example of a managed memory device is a managed NAND (MNAND) device.

The memory sub-system controller 115 includes a VTC velocity component 113 that enables or facilitates the memory sub-system controller 115 to dynamically perform GC operations. Specifically, the VTC velocity component 113 can generate a request to perform a GC operation on data stored on a memory device 130 or memory device 140 and, in response, accesses a valid translation unit count (VTC) velocity of each portion of a plurality of portions (e.g., BSs) of the data stored on the memory device 130 or memory device 140. The VTC velocity component 113 selects an individual portion of the plurality of portions based on the VTC velocity of the individual portion and performs the GC operation on the selected individual portion. Any discussion with respect to the memory device 130 can similarly be applied to the memory device 140.

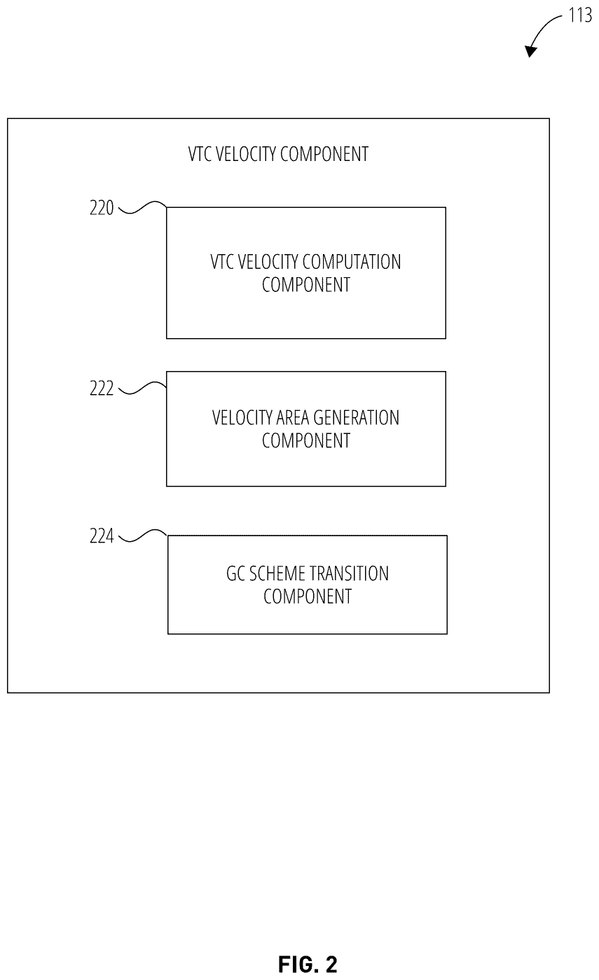

FIG. 2 is a block diagram of a VTC velocity component 113, in accordance with some examples. The VTC velocity component 113 can include a VTC velocity computation component 220, a velocity area generation component 222, and a GC scheme transition component 224. The VTC velocity computation component 220 can monitor when memory blocks or portions that are being written or programmed are closed. While the below discussion pertains to block stripes or memory blocks, similar techniques are applicable to any other portion of storage.

Specifically, memory blocks in the memory device 130 can be either in an open state or a closed state. When a block is open or in the open state, it is available to receive new data from host write operations. As data is written to the block, it gradually fills up. Once the block reaches its capacity or meets certain criteria set by the memory sub-system controller 115, it transitions to a closed state. A closed block is no longer accepting new writes and becomes a candidate for GC processes. The flash translation layer (FTL) keeps track of these closed blocks, monitoring their valid data count and other metrics to determine when and how to perform garbage collection on them, as discussed below.

In some examples, once the BS transitions to the closed state, the VTC velocity computation component 220 can obtain the VTC (or VTC value) of the BS. This represents the number of valid pages or other storage units within the BS that include or contain valid data. The VTC velocity computation component 220 also obtains a timestamp representing when the BS has been transitioned to the closed state. The VTC velocity computation component 220 stores both of these values (e.g., the timestamp representing when the BS has transitioned to the closed state and the VTC that was determined at the time the BS transitioned to the closed state) in association with the BS. In this way, each BS or each memory portion can be associated with a respective set of information indicating when the corresponding BS has transitioned to the closed state and the VTC that was determined at the time the corresponding BS transitioned to the closed state. This information is used by the VTC velocity computation component 220 to compute the VTC velocity of each BS.

For example, the VTC velocity computation component 220 can receive, generate, or access a request to perform GC operations on the data stored in/on the memory device 130. At that time (or at any other time or periodic interval), the VTC velocity computation component 220 computes a VTC velocity for each closed BS. To do so, the VTC velocity computation component 220 can identify a first BS. The VTC velocity computation component 220 retrieves the data associated with the first BS indicating when the first BS was transitioned to the closed state and the VTC that was determined at the time the BS transitioned to the closed state. The VTC velocity computation component 220 determines the current VTC of the first BS and computes a difference between the VTC that was determined at the time the BS transitioned to the closed state and the current VTC. The VTC velocity computation component 220 computes a duration of time that the first BS has been closed based on a difference between the timestamp indicating when the first BS transitioned to the closed state and a current time. The VTC velocity computation component 220 divides the difference between the VTC that was determined at the time the first BS transitioned to the closed state and the current VTC by the computed duration of time. In some cases, the VTC velocity computation component 220 multiplies this divided value by an amplifier, constant or other coefficient to generate or compute the VTC velocity of the first BS. Specifically, the VTC velocity computation component 220 can compute the VTC velocity of each BS according to the following equation:

$$VTC Velocity = \frac{VTC when BS closed - VTC at present}{Time at present - Time of when BS closed} \times Amplifier$$

The VTC velocity computation component 220 can retrieve the data associated with a second BS indicating when the second BS was transitioned to the closed state and the VTC that was determined at the time the second BS transitioned to the closed state. The VTC velocity computation component 220 determines the current VTC of the second BS and computes a difference between the VTC that was determined at the time the second BS transitioned to the closed state and the current VTC. The VTC velocity computation component 220 computes a duration of time that the second BS has been closed based on a difference between the timestamp indicating when the second BS transitioned to the closed state and a current time. The VTC velocity computation component 220 divides the difference between the VTC that was determined at the time the second BS transitioned to the closed state and the current VTC by the computed duration of time. In some cases, the VTC velocity computation component 220 multiplies this divided value by an amplifier, constant or other coefficient to generate or compute the VTC velocity of the second BS. This process is repeated for each closed BS stored in the memory device 130.

The more hot data one BS contains, the higher the VTC velocity will be, along with host workload continuing. The less hot data one BS contains, the lower the VTC velocity will be, along with host workload continuing. The VTC velocity component 113 can compact cold data together in the GC operations which improves the WA.

In some examples, the VTC velocity computation component 220 communicates the computed VTC velocities to the GC scheme transition component 224. The GC scheme transition component 224 can then identify one of the BSs that has the lowest VTC velocity. The GC scheme transition component 224 can then select that identified BS for performing GC operations. Namely, the GC scheme transition component 224 can perform GC operations on the BSs having the smallest VTC velocity first before performing the GC operations on other BSs. In some cases, the VTC velocity computation component 220 can count how many iterations have been performed in which BSs were selected for performing GC based on the VTC velocity of the BSs. In response to determining that the number of iterations transgresses a specified iteration threshold, the GC scheme transition component 224 transitions to another GC scheme. For example, after selecting candidate BSs for GC operations based on the VTC velocity of the BSs has been performed for the threshold number of iterations, the GC scheme transition component 224 transitions to selecting the candidate BSs based on the raw or actual VTC values. In such cases, the GC scheme transition component 224 can select the BSs having the lowest VTC for GC before selecting other BSs.

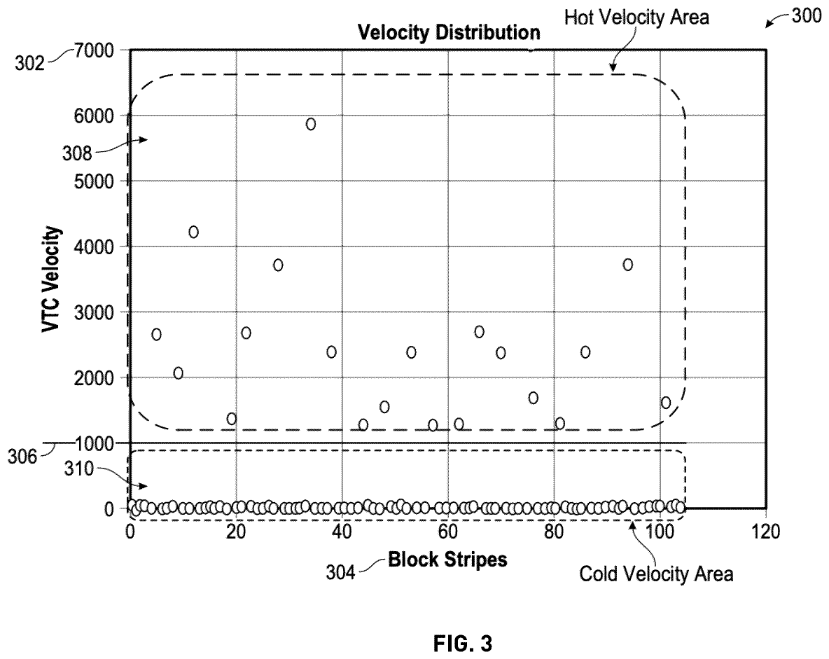

In some examples, the VTC velocity computation component 220 can communicate the computed VTC velocities to the velocity area generation component 222. The velocity area generation component 222 can access a VTC velocity threshold. Using the VTC velocity threshold, the velocity area generation component 222 can generate hot and cold velocity areas. For example, the velocity area generation component 222 can compare the VTC velocity of each BS to the VTC velocity threshold, such as the VTC velocity threshold 306, shown in diagram 300 of FIG. 3. Namely, diagram 300 includes various VTC velocities 302 and various block stripes 304. The velocity area generation component 222 can determine that a first set of BSs have respective VTC velocities 302 that transgress the VTC velocity threshold 306. The velocity area generation component 222 can then place the first set of BSs in the hot velocity area 308. The velocity area generation component 222 can determine that a second set of BSs have respective VTC velocities 302 that fail to transgress the VTC velocity threshold 306. The velocity area generation component 222 can then place the second set of BSs in the cold velocity area 310. The velocity area generation component 222 can continuously or periodically update the diagram 300 as new VTC velocities are received/computed by the VTC velocity computation component 220. The VTC velocity threshold 306 can be configured and/or adjusted by the host system 120 or can be of a specified value that is set during manufacture of the memory sub-system 110.

In some examples, the GC scheme transition component 224 can select the GC scheme based on the VTC velocity, whether a BS falls in the hot velocity area 308 or cold velocity area 310, and/or based on the VTC of each BS. Specifically, the GC scheme transition component 224 can initiate, by default, GC operations based on the VTC velocity of each BS. In such cases, the GC scheme transition component 224 can randomly select/identify a BS from one of the many closed BSs regardless of whether the BS is in the hot velocity area 308 or cold velocity area 310.

The GC scheme transition component 224 can then obtain the VTC velocity information from the VTC velocity computation component 220, such as in response to detecting a condition for performing GC. The GC scheme transition component 224 can access/obtain the diagram 300 (the list of BSs that fall in the hot velocity area 308 and cold velocity area 310). The GC scheme transition component 224 can select a candidate BS for performing GC from the cold velocity area 310. To do so, the GC scheme transition component 224 can search the VTC velocity values of each BS that is in the cold velocity area 310. The GC scheme transition component 224 can select a particular BS that is in the cold velocity area 310 and has the smallest VTC velocity value among all the VTC velocity values of the BSs in the cold velocity area 310. The GC scheme transition component 224 can then perform GC on the particular BS that is selected and that has the smallest VTC velocity.

In some cases, the GC scheme transition component 224 can also (while performing the GC operation on the particular BS or before) search the list of BSs that are in the hot velocity area 308. The GC scheme transition component 224 can identify a given BS that is in the hot velocity area 308 and which has a corresponding actual/raw VTC that is lower than all other VTC of other BSs in the hot velocity area 308. The GC scheme transition component 224 can then determine whether the given BS is the same as the randomly selected BS. If so, the GC scheme transition component 224 can perform subsequent selections of candidate BSs for GC according to a different GC scheme. For example, the GC scheme transition component 224 can subsequently select BSs for GC based on their respective actual VTC values rather than the VTC velocity similar to the greedy approach mentioned previously. If the given BS is different from the randomly selected BS, the GC scheme transition component 224 can continue to compute VTC velocities and control the selection of candidate BSs for GC according to their respective VTC velocity values and based on whether such BSs are in the cold velocity area 310 or hot velocity area 308.

In some examples, the GC scheme transition component 224 can compute a BS score for each BS that is in the hot velocity area 308 or cold velocity area 310. This can be performed when the GC scheme transition component 224 transitions to the second GC scheme or during initial operation of the system. The GC scheme transition component 224 can compute the BS score based on a combination of the actual/raw current VTC value of each BS and/or the VTC velocity. For example, the GC scheme transition component 224 can compute a first score for a first BS by summing the current VTC value of the first BS with the VTC velocity of the first BS adjusted by a velocity coefficient. Namely, the BS score can be combined in accordance with the following equation: BS_{Score}=VTC+Velocity_{Coefficient}*VTC_{Velocity}. The velocity coefficient can be dynamically adjusted by the host system 120 or can be of a predefined value. The GC scheme transition component 224 can similarly compute a second score for a second BS by summing the current VTC value of the second BS with the VTC velocity of the second BS adjusted by the velocity coefficient. The GC scheme transition component 224 can then select one of the BSs for GC based on their respective scores. For example, the GC scheme transition component 224 can select a BS having a lowest BS score among all the rest of the BSs as the candidate for performing GC. The VTC velocity coefficient can be 0.35, 0.5 or any other suitable value.

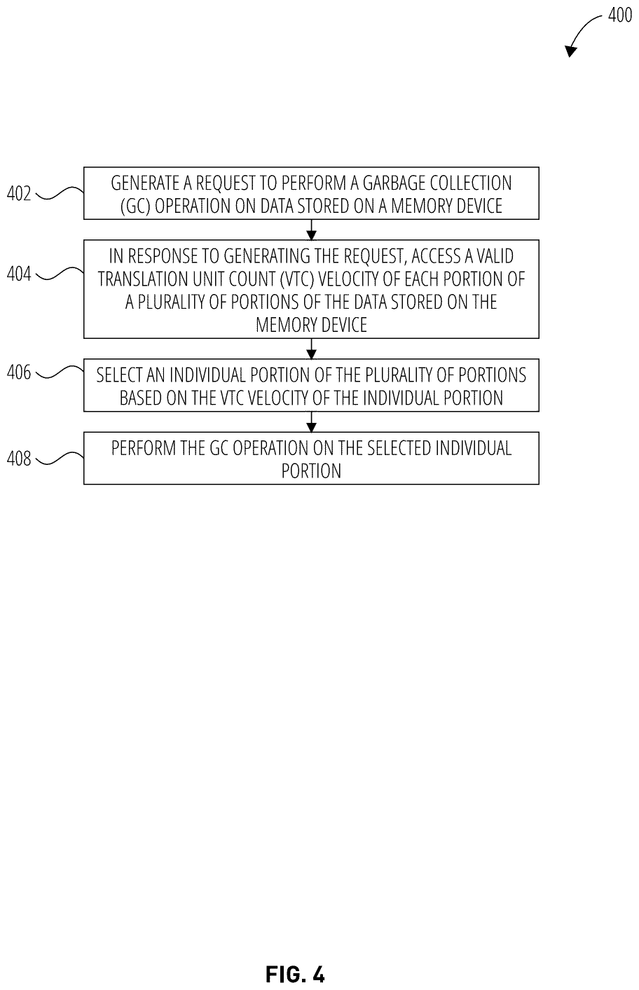

FIG. 4 is a flow diagram of an example method 400 to perform GC operations, in accordance with some examples. Method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 400 is performed by the memory sub-system controller 115 or subcomponents of the memory sub-system controller 115 of FIG. 1. In these examples, the method 400 can be performed, at least in part, by the VTC velocity component 113. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example. Other process flows are possible.

Referring now to FIG. 4, the method 400 begin at operation 402, with the VTC velocity component 113 of a memory sub-system 110 (e.g., memory device 140) generating a request to perform a garbage collection (GC) operation on data stored on a memory device 140. The VTC velocity component 113, in response to generating the request, accesses a valid translation unit count (VTC) velocity of each portion of a plurality of portions of the data stored on the memory device 140 at operation 404. Then, the VTC velocity component 113, at operation 406 selects an individual portion of the plurality of portions based on the VTC velocity of the individual portion and, at operation 408, performs the GC operation on the selected individual portion.

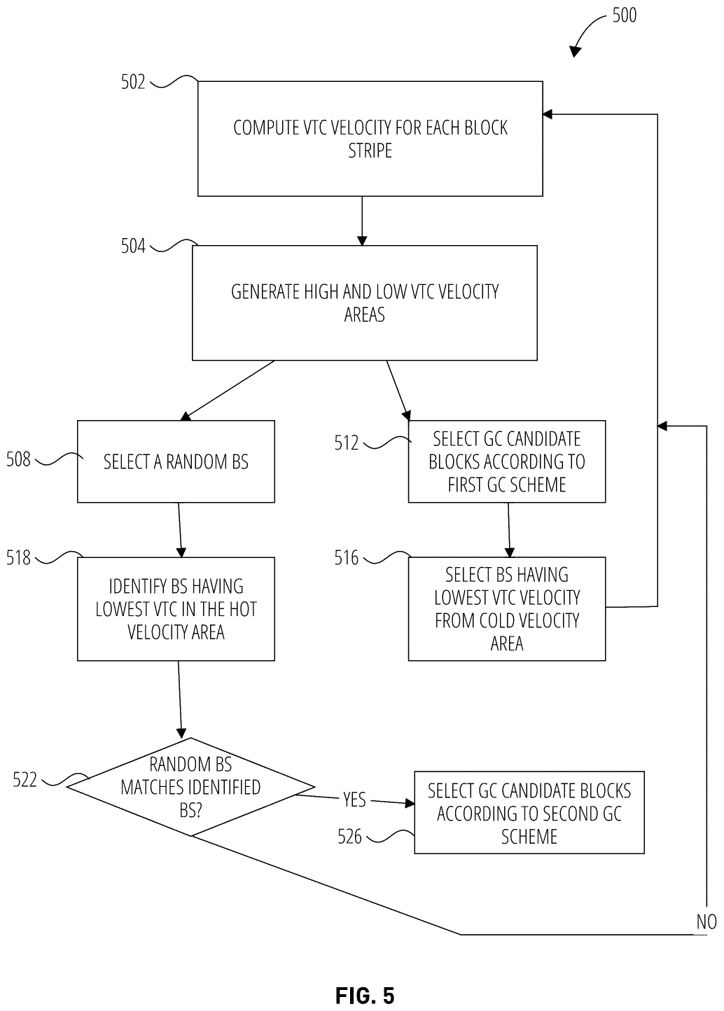

FIG. 5 is a flow diagram of an example method 500 to perform GC operations, in accordance with some examples. Method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 500 is performed by the memory sub-system controller 115 or subcomponents of the memory sub-system controller 115 of FIG. 1. In these examples, the method 500 can be performed, at least in part, by the VTC velocity component 113. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example. Other process flows are possible.

Referring now to FIG. 5, the method 500 begin at operation 502, with the VTC velocity component 113 of a memory sub-system 110 (e.g., memory device 140) computing the VTC velocity for each BS (e.g., portion of a plurality of portions stored/closed on the memory device 140). The VTC velocity component 113, at operation 504, generates high and low VTC velocity areas. Then, the VTC velocity component 113 randomly selects a BS at operation 508 and selects a GC candidate BS according to a first GC scheme at operation 512. The VTC velocity component 113 selects the BS having a lowest VTC velocity from a cold velocity area (e.g., cold velocity area 310) at operation 516. The VTC velocity component 113 then performs the GC operation on the selected BS.

The VTC velocity component 113, at operation 518, identifies a BS that has a lowest VTC among other BSs in the hot velocity area (e.g., the hot velocity area 308). The VTC velocity component 113 determines, at operation 522, whether the identified BS that has the lowest VTC is the same as (e.g., matches) the BS that was randomly selected from the hot or cold VTC velocity area. In response to determining that the BSs match, the VTC velocity component 113 performs operation 526 where subsequent BSs are selected for GC according to a second GC scheme. Otherwise, the VTC velocity component 113 performs operation 502 to continue computing VTC velocities of closed BSs.

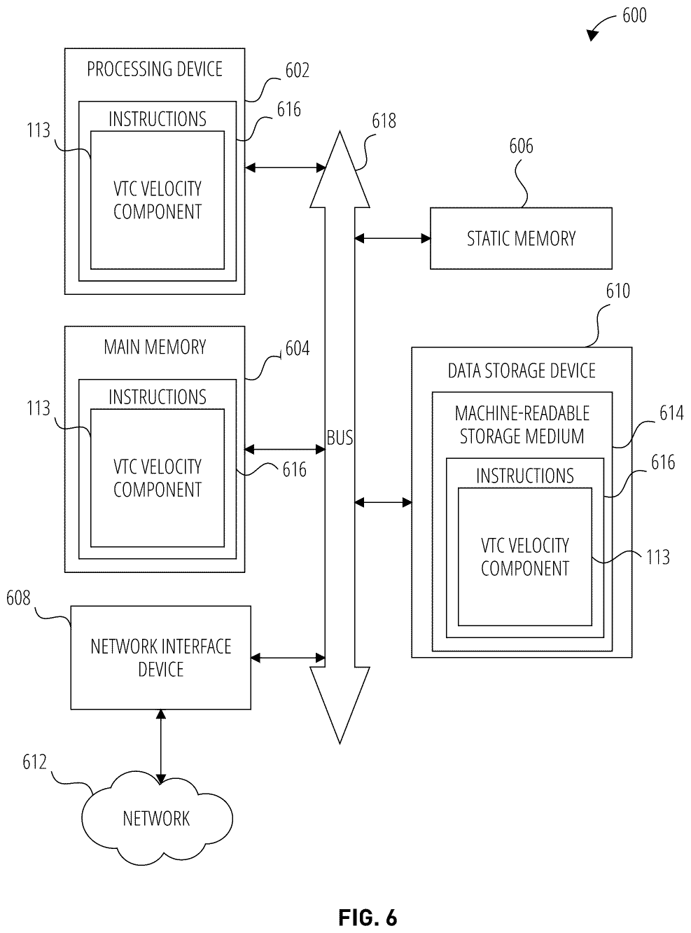

FIG. 6 illustrates an example machine in the form of a computer system 600 within which a set of instructions can be executed for causing the machine to perform any one or more of the methodologies discussed herein. In some examples, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or Rambus DRAM (RDRAM), etc.), a static memory 606 (e.g., flash memory, static random access memory (SRAM), etc.), and a data storage device 610, which communicate with each other via a bus 618.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application-specific integrated circuit (ASIC), a field programmable gate array (FPGA), a digital signal processor (DSP), a network processor, or the like. The processing device 602 is configured to execute instructions 616 for performing the operations and steps discussed herein. The computer system 600 can further include a network interface device 608 to communicate over a network 612.

The data storage device 610 can include a machine-readable storage medium 614 (also known as a computer-readable medium) on which is stored one or more sets of instructions 616 or software embodying any one or more of the methodologies or functions described herein. The instructions 616 can also reside, completely or at least partially, within the main memory 604 and/or within the processing device 602 during execution thereof by the computer system 600, the main memory 604 and the processing device 602 also constituting machine-readable storage media. The machine-readable storage medium 614, data storage device 610, and/or main memory 604 can correspond to the memory sub-system 110 of FIG. 1.

In one example, the instructions 616 include instructions to implement functionality corresponding to providing block failure protection for a zone memory sub-system as described herein (e.g., the VTC velocity component 113 of FIG. 1). While the machine-readable storage medium 614 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1. A system comprising: a memory device; and a processing device, operatively coupled to the memory device, configured to perform operations comprising: generating a request to perform a garbage collection (GC) operation on data stored on the memory device; in response to generating the request, accessing a valid translation unit count (VTC) velocity of each portion of a plurality of portions of the data stored on the memory device; selecting an individual portion of the plurality of portions based on the VTC velocity of the individual portion; and performing the GC operation on the selected individual portion.

Example 2. The system of Example 1, wherein the plurality of portions comprises a plurality of block stripes.

Example 3. The system of any one of Examples 1-2, the operations comprising: storing, for each portion of the plurality of portions, a VTC when the respective portion was closed; and computing the VTC velocity of each portion as a function of the stored VTC when the respective portion was closed and a duration of time that has elapsed since the respective portion was closed.

Example 4. The system of Example 3, the operations comprising: obtaining a first VTC value corresponding to the VTC value associated with the individual portion when the individual portion was closed; obtaining a second VTC value corresponding to a current VTC associated with the individual portion; computing a difference between the first and second VTC values; and computing an individual duration of time that has elapsed since the individual portion was closed.

Example 5. The system of Example 4, the operations comprising: computing the VTC velocity for the individual portion based on a division of the computed difference and the individual duration of time; and applying an amplification value to the computed VTC velocity for the individual portion.

Example 6. The system of Example 5, wherein the VTC velocity of the individual portion comprises a first VTC velocity, the operations comprising: computing a second VTC velocity for an additional portion of the plurality of portions; determining that the first VTC velocity is lower than the second VTC velocity, wherein the individual portion is selected instead of the additional portion for performing the GC operation in response to determining that the first VTC velocity is lower than the second VTC velocity.

Example 7. The system of any one of Examples 1-6, the operations comprising: detecting a condition for transitioning from selecting a target portion for performing the GC operation based on a VTC velocity of the target portion to selecting the target portion based on a corresponding VTC of the target portion; and in response to determining that the condition is satisfied, selecting the target portion based on the corresponding VTC of the target portion relative to VTCs of remaining portions in the plurality of portions.

Example 8. The system of Example 7, wherein the target portion selected based on the corresponding VTC is selected in response to determining that the target portion is associated with a lowest VTC among VTCs of each of the plurality of portions.

Example 9. The system of any one of Examples 7-8, the operations comprising: determining that selection of the target portion based on the VTC velocity has been performed for a threshold number of iterations; and determining that the condition is satisfied in response to determining that the selection of the target portion based on the VTC velocity has been performed for the threshold number of iterations.

Example 10. The system of any one of Examples 7-9, the operations comprising: obtaining VTCs of each portion of the plurality of portions; identifying a lowest VTC of the obtained VTCs; and selecting the target portion in response to determining that the target portion is associated with the lowest VTC.

Example 11. The system of Example 10, the operations comprising: determining that the target portion selected based on identifying the lowest VTC is the same as the individual portion selected based on the VTC velocity of the individual portion; and determining that the condition is satisfied in response to determining that the target portion selected based on identifying the lowest VTC is the same as the individual portion selected based on the VTC velocity of the individual portion.

Example 12. The system of any one of Examples 1-11, the operations comprising: generating a cold velocity area comprising a first subset of the plurality of portions having corresponding VTC velocities that are below a VTC velocity threshold; and generating a hot velocity area comprising a second subset of the plurality of portions having the corresponding VTC velocities that are above the VTC velocity threshold.

Example 13. The system of Example 12, wherein the VTC velocity threshold is configurable.

Example 14. The system of any one of Examples 12-13, the operations comprising: selecting the individual portion from the cold velocity area.

Example 15. The system of Example 14, the operations comprising: randomly selecting a first portion from the hot velocity area or cold velocity area; identifying a lowest VTC candidate portion in the hot velocity area having a corresponding VTC that is lower than VTCs of other portions in the hot velocity area; determining that the first portion that was randomly selected matches the lowest VTC candidate portion; and performing subsequent GC operations on the plurality of portions based on lowest VTCs of the plurality of portions in response to determining that the first portion that was randomly selected matches the lowest VTC candidate portion.

Example 16. The system of any one of Examples 1-15, the operations comprising: computing a block stripe score for each portion of the plurality of portions as a function of the VTC of each portion and the VTC velocity of each portion, wherein the individual portion is selected based on the block stripe score.

Example 17. The system of Example 16, wherein the block stripe score for the individual portion is computed by summing the VTC of the individual portion with the VTC velocity of the individual portion multiplied by a VTC velocity coefficient.

Example 18. At least one non-transitory machine-readable storage medium comprising instructions that, when executed by a processing device, cause the processing device to perform operations comprising: generating a request to perform a garbage collection (GC) operation on data stored on a memory device; in response to generating the request, accessing a valid translation unit count (VTC) velocity of each portion of a plurality of portions of the data stored on the memory device; selecting an individual portion of the plurality of portions based on the VTC velocity of the individual portion; and performing the GC operation on the selected individual portion.

Example 19. The at least one non-transitory machine-readable storage medium of Example 18, wherein the plurality of portions comprises a plurality of block stripes.

Example 20. A method comprising: generating a request to perform a garbage collection (GC) operation on data stored on a memory device; in response to generating the request, accessing a valid translation unit count (VTC) velocity of each portion of a plurality of portions of the data stored on the memory device; selecting an individual portion of the plurality of portions based on the VTC velocity of the individual portion; and performing the GC operation on the selected individual portion.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, examples of the disclosure have been described with reference to specific examples thereof. It will be evident that various modifications can be made thereto without departing from the broader spirit and scope of examples of the disclosure as set forth in the following claims. The specification and drawings are, accordingly, to be regarded in an illustrative sense rather than a restrictive sense.

1. A system comprising:
a memory device; and
a processing device, operatively coupled to the memory device, configured to perform operations comprising:
generating a request to perform a garbage collection (GC) operation on data stored on the memory device;
storing, at a first time, a valid translation unit counts (VTCs) for a plurality of portions of the data stored on the memory device, a first portion of the plurality of portions being associated with an individual VTC of the VTCs at the first time;
generating, at a current time, based on the VTC stored at the first time, VTC velocities for the plurality of portions of the data stored on the memory device, an individual VTC velocity of the VTC velocities for the first portion being generated a function of the individual VTC of the first portion stored at the first time, a current VTC of the first portion, and an elapsed time between the first time and the current time;
in response to generating the request, accessing the VTC velocity of each portion of a plurality of portions of the data stored on the memory device;
selecting an individual portion of the plurality of portions based on the VTC velocity of the individual portion; and
performing the GC operation on the selected individual portion.

2. The system of claim 1, wherein the plurality of portions comprises a plurality of block stripes.

3. The system of claim 1, the operations comprising:
storing, for each portion of the plurality of portions, a VTC when the respective portion was closed; and
computing the VTC velocity of each portion as a function of the stored VTC when the respective portion was closed and a duration of time that has elapsed since the respective portion was closed.

4. The system of claim 3, the operations comprising:
obtaining a first VTC value corresponding to the VTC value associated with the individual portion when the individual portion was closed;
obtaining a second VTC value corresponding to a current VTC associated with the individual portion;
computing a difference between the first and second VTC values; and
computing an individual duration of time that has elapsed since the individual portion was closed.

5. The system of claim 4, the operations comprising:
computing the VTC velocity for the individual portion based on a division of the computed difference and the individual duration of time; and
applying an amplification value to the computed VTC velocity for the individual portion.

6. The system of claim 5, wherein the VTC velocity of the individual portion comprises a first VTC velocity, the operations comprising:
computing a second VTC velocity for an additional portion of the plurality of portions; and
determining that the first VTC velocity is lower than the second VTC velocity, wherein the individual portion is selected instead of the additional portion for performing the GC operation in response to determining that the first VTC velocity is lower than the second VTC velocity.

7. The system of claim 1, the operations comprising:
detecting a condition for transitioning from selecting a target portion for performing the GC operation based on a VTC velocity of the target portion to selecting the target portion based on a corresponding VTC of the target portion; and
in response to determining that the condition is satisfied, selecting the target portion based on the corresponding VTC of the target portion relative to VTCs of remaining portions in the plurality of portions.

8. The system of claim 7, wherein the target portion selected based on the corresponding VTC is selected in response to determining that the target portion is associated with a lowest VTC among VTCs of each of the plurality of portions.

9. The system of claim 7, the operations comprising:
determining that selection of the target portion based on the VTC velocity has been performed for a threshold number of iterations; and
determining that the condition is satisfied in response to determining that the selection of the target portion based on the VTC velocity has been performed for the threshold number of iterations.

10. The system of claim 7, the operations comprising:
obtaining VTCs of each portion of the plurality of portions;
identifying a lowest VTC of the obtained VTCs; and
selecting the target portion in response to determining that the target portion is associated with the lowest VTC.

11. The system of claim 10, the operations comprising:
determining that the target portion selected based on identifying the lowest VTC is the same as the individual portion selected based on the VTC velocity of the individual portion; and
determining that the condition is satisfied in response to determining that the target portion selected based on identifying the lowest VTC is the same as the individual portion selected based on the VTC velocity of the individual portion.

12. The system of claim 1, the operations comprising:
generating a cold velocity area comprising a first subset of the plurality of portions having corresponding VTC velocities that are below a VTC velocity threshold; and
generating a hot velocity area comprising a second subset of the plurality of portions having the corresponding VTC velocities that are above the VTC velocity threshold.

13. The system of claim 12, wherein the VTC velocity threshold is configurable.

14. The system of claim 12, the operations comprising:
selecting the individual portion from the cold velocity area.

15. The system of claim 14, the operations comprising:
randomly selecting a first portion from the hot velocity area or the cold velocity area;
identifying a lowest VTC candidate portion in the hot velocity area having a corresponding VTC that is lower than VTCs of other portions in the hot velocity area;
determining that the first portion that was randomly selected matches the lowest VTC candidate portion; and
performing subsequent GC operations on the plurality of portions based on lowest VTCs of the plurality of portions in response to determining that the first portion that was randomly selected matches the lowest VTC candidate portion.

16. The system of claim 1, the operations comprising:
computing a block stripe score for each portion of the plurality of portions as a function of the VTC of each portion and the VTC velocity of each portion, wherein the individual portion is selected based on the block stripe score.

17. The system of claim 16, wherein the block stripe score for the individual portion is computed by summing the VTC of the individual portion with the VTC velocity of the individual portion multiplied by a VTC velocity coefficient.

18. At least one non-transitory machine-readable storage medium comprising instructions that, when executed by a processing device, cause the processing device to perform operations comprising:
generating a request to perform a garbage collection (GC) operation on data stored on a memory device;
storing, at a first time, a valid translation unit counts (VTCs) for a plurality of portions of the data stored on the memory device, a first portion of the plurality of portions being associated with an individual VTC of the VTCs at the first time;
generating, at a current time, based on the VTC stored at the first time, VTC velocities for the plurality of portions of the data stored on the memory device, an individual VTC velocity of the VTC velocities for the first portion being generated a function of the individual VTC of the first portion stored at the first time, a current VTC of the first portion, and an elapsed time between the first time and the current time;
in response to generating the request, accessing the VTC velocity of each portion of a plurality of portions of the data stored on the memory device;
selecting an individual portion of the plurality of portions based on the VTC velocity of the individual portion; and
performing the GC operation on the selected individual portion.

19. The at least one non-transitory machine-readable storage medium of claim 18, wherein the plurality of portions comprises a plurality of block stripes.

20. A method comprising:
generating a request to perform a garbage collection (GC) operation on data stored on a memory device;
storing, at a first time, a valid translation unit counts (VTCs) for a plurality of portions of the data stored on the memory device, a first portion of the plurality of portions being associated with an individual VTC of the VTCs at the first time;
generating, at a current time, based on the VTC stored at the first time, VTC velocities for the plurality of portions of the data stored on the memory device, an individual VTC velocity of the VTC velocities for the first portion being generated a function of the individual VTC of the first portion stored at the first time, a current VTC of the first portion, and an elapsed time between the first time and the current time;
in response to generating the request, accessing the VTC velocity of each portion of a plurality of portions of the data stored on the memory device;
selecting an individual portion of the plurality of portions based on the VTC velocity of the individual portion; and
performing the GC operation on the selected individual portion.
